(19) United States
(12) Patent Application Publication
(10) Pub. No.: US 2009/0088074 A1
(43) Pub. Date: Apr. 2, 2009

(54) ENCLOSED SPACE COMMUNICATION SYSTEMS AND RELATED METHODS

(76) Inventors: Douglas V. Limbaugh, Glendale, AZ (US); Patrick A. Murphy, Phoenix, AZ (US); Brian L. Pease, Milton, VT (US); Metthew J. Savoca, Peoria, AZ (US); Geoffrey D. Simms, Phoenix, AZ (US)

Correspondence Address: BOOTH UDALL, PLC, 1155 W. Rio Salado Pkwy., Suite 101, Tempe, AZ, 85281, US

(21) Appl. No.: 12/177,063

(22) Filed: Jul. 21, 2008

Related U.S. Application Data
(60) Provisional application No. 60/951,027, filed on Jul. 20, 2007.

(51) Int. Cl. H04B 7/14

(52) U.S. Cl. 455/22

(57) ABSTRACT

Systems and methods for communication in enclosed areas. Implementations of a method may include sending a first high frequency (HF) signal using a first HF radio, receiving the first HF signal with a first medium frequency (MF) repeater, converting the first HF signal to an MF signal using the first MF repeater, and sending the MF signal to one or more second MF repeaters located in an enclosed space. The method may include receiving the MF signal with the one or more second MF repeaters, converting the MF signal to a second HF signal using the one or more second MF repeaters, and sending the second HF signal to a second HF radio. Implementations of radio communication systems may utilize MF repeaters with MF antennas which may be omnidirectional.

### CROSS-REFERENCE TO RELATED APPLICATIONS

This document claims the benefit of the filing date of U.S. Provisional Patent Application No. 60/951,027, entitled “HF-MF/MF-HF Converters, Emergency Communication Systems, and Methods of Use” to Limbaugh, et al. which was filed on Jul. 20, 2007, the disclosure of which is hereby incorporated entirely herein by reference.

### STATEMENT REGARDING FEDERALLY SPONSORED RESEARCH OR DEVELOPMENT

The U.S. Government has a paid-up license in implementations of systems and methods disclosed in this document and the right in limited circumstances to require the patent owner to license others on reasonable terms as provided for by the terms of contract No. W15P7T-06-C-K203 awarded by the United States Army.

### BACKGROUND

1. Technical Field

Aspects of this document relate generally to telecommunications systems and methods involving radio frequency electromagnetic signals.

2. Background Art

Telecommunication systems, particularly radio communication systems utilizing radio frequency electromagnetic signals, are used in many applications to allow wireless communication of voice and data over long distances. A large number of techniques are employed in conventional radio communication systems that alter properties of the radio frequency waves used in order to transmit the information, such as amplitude modulation (AM) or frequency modulation (FM). Many radio communication systems are “line-of-sight,” meaning that reliable communication can be achieved only when there are no physical barriers such as hills or buildings between the transmitter and the receiver. The radio spectrum used for line-of-sight wireless networking systems is typically between 300 MHz to 5 GHz. Some line-of-sight systems, such as the 802.11a protocol operating at 5 GHz, have some limited ability to penetrate through various solid obstacles such as walls and the roofs of buildings; however, in these situations, the signal strength can vary significantly because of the signal attenuation that occurs through the interaction of the signal and the obstacles.

### SUMMARY

Implementations of communication systems for use in enclosed spaces may include a first implementation of a radio communication system. The system may include a high frequency (HF) antenna configured to receive a first analog HF signal and to send a second analog HF signal. A high frequency to medium frequency (HF-MF) converter module may be coupled with the HF antenna and may be configured to receive the first analog HF signal from the HF antenna and to convert the first analog HF signal to a first analog MF signal. The HF-MF converter module may be further configured to receive a second analog MF signal, convert the second analog MF signal to a second analog HF signal, and send the second analog HF signal to the HF antenna. An omnidirectional antenna may be coupled with the HF-MF analog converter module and may include a wire loop and a single ferrite rod loop oriented substantially parallel to a plane formed by the wire loop. The omnidirectional antenna may be configured to receive the first analog MF signal from the HF-MF analog converter module and transmit the first analog MF signal into an enclosed space as well as receive the second analog MF signal from the enclosed space and send the second analog MF signal to the HF-MF analog converter module.

Implementations of first implementations of radio communication systems may include one, all, or some of the following:

The HF-MF analog converter module may include an HF conversion side having a first HF demodulator coupled with a first MF modulator, the first HF demodulator configured to convert the first analog HF signal to a first analog baseband signal and the first MF modulator configured to convert the first analog baseband signal to the first analog MF signal. An MF conversion side may also be included having a second MF demodulator coupled with a second HF modulator and configured to convert the second analog MF signal to a second analog baseband signal and the second HF modulator configured to convert the second analog baseband signal to the second analog HF signal.

The HF-MF analog converter module may include an HF conversion side having a first radio frequency (RF) mixer configured to multiply the first analog HF signal with a first analog pure wave signal to produce an intermediate analog MF signal including the first analog MF signal and a first analog sum frequency signal. A low pass filter may be coupled with the first RF mixer and may be configured to receive the intermediate analog MF signal and to filter the first analog sum frequency signal to produce the first analog MF signal. An MF conversion side may also be included and may have a second RF mixer configured to multiply the second analog MF signal with a second analog pure wave signal to produce an intermediate analog HF signal having the second analog HF signal and a second analog sum frequency signal. A high pass filter may be coupled with the second RF mixer and may be configured to receive the intermediate analog HF signal and to filter the second analog sum frequency signal to produce the second analog HF signal.

The omnidirectional antenna may be further configured to transmit the first analog MF signal to a conductor included in the enclosed space and to receive the second analog MF signal from the conductor.

A second implementation of a radio communication system may include an HF antenna configured to receive a first analog HF signal and to send a second analog HF signal. An HF-MF digital converter module coupled with the HF antenna may also be included having an HF conversion side. The HF conversion side may include an HF demodulator configured to convert the first analog HF signal to a first analog baseband signal and a digital modulator coupled with the HF demodulator. The digital modulator may include a low pass filter, an analog-to-digital (A/D) converter and a constant amplitude digital modulator. The low pass filter and the A/D converter may be configured to convert the first analog baseband signal to a first digital baseband signal and the constant amplitude modulator may be configured to combine the first digital baseband signal with an MF carrier signal to produce a first digital MF signal. An MF conversion side may also be included having a constant amplitude digital demodulator configured to convert a second digital MF signal to a second digital baseband signal. A digital-to-analog (D/A) converter and a low pass filter may be included configured to convert the second digital baseband signal to a second analog MF signal. An HF modulator may also be included and may be configured to convert the second analog MF signal to a second analog HF signal. An MF antenna coupled with the HF-MF antenna may be coupled with the HF-MF digital converter module and may be configured to receive the first digital MF signal from the HF-MF digital converter module and transmit the first digital MF signal into an enclosed space and also receive the second digital MF signal from the enclosed space and send the second digital MF signal to the HF-MF digital converter.

Implementations of a second radio communication system may include one, all, or some of the following:

The MF antenna may be an omnidirectional antenna coupled with the HF-MF digital converter module and may include a wire loop and a single ferrite rode loop, where the single ferrite rod loop is oriented substantially parallel to a plane formed by the wire loop.

The MF antenna may be further configured to transmit the first digital MF signal to a conductor included in the enclosed space and to receive the second digital MF signal from the conductor.

Implementations of radio communication systems may utilize radio frequency repeaters, some of which may be implementations of HF-MF repeaters or MF repeaters. Implementations of HF-MF repeaters may include an HF antenna coupled with the HF-MF repeater and configured to receive a first HF signal and to send a second HF signal to one or more HF radios. A MF antenna may be coupled with the HF-MF repeater and may be configured to receive a second MF signal and to send a first MF signal to one or more MF repeaters. A frequency translating circuit may be coupled with the MF antenna and with the HF antenna. An MF transceiver may be coupled with the MF antenna and an HF transceiver may be coupled with the HF antenna. Implementations of HF-MF repeaters may include one, all, or some of the following:

The first MF signal may be a first digital MF signal, the second MF signal may be a second digital MF signal, the radio board may be a digital radio board, and the MF transceiver may be a digital transceiver.

The first MF signal may be a first analog MF signal, the second MF signal may be a second analog MF signal, the radio board may be an analog radio board, and the MF transceiver may be an analog MF transceiver.

The MF antenna may be further configured to send the first MF signal to or to receive the second MF signal from a conductor.

A keyboard may be included that is configured to input one or more characters and a display may be included that is configured to show one or more characters. The keyboard and the display may be coupled with the HF-MF repeater and coupled with a digital input/output (I/O) control board.

The HF transceiver may be configured to send two or more HF signals to a plurality of HF radios and may be configured to receive two or more HF signals from a plurality of HF radios.

The HF-MF repeater may include a housing and the HF antenna and the MF antenna may extend from the housing. One or more I/O ports may also be included in a surface of the housing.

The MF antenna may be an omnidirectional antenna coupled with the HF-MF repeater and may include a wire loop and a single ferrite rod loop, where the single ferrite rod loop may be oriented substantially parallel to a plane formed by the wire loop.

A battery charging circuit may be coupled with the HF-MF repeater and may include a battery coupled with the HF-MF repeater.

The frequency translating circuit may further include an antenna matching circuit and a radio circuit.

The frequency translating circuit, the antenna matching circuit, and the radio circuit may be included in one or more boards.

Implementations of radio communication systems and HF-MF repeaters may utilize various implementations of a method of communicating voice or data information in an enclosed space. The method may include sending a first HF signal using a first HF radio, the first HF signal including voice information or data information received by the first HF radio. The method may also include receiving the first HF signal with a first MF repeater, converting the first HF signal to an MF signal corresponding with the first HF signal using the first MF repeater, and sending the MF signal using the first MF repeater to one or more second MF repeaters located in an enclosed space. The method may also include receiving the MF signal with the one or more second MF repeaters located in the enclosed space, converting the MF signal to a second HF signal corresponding with the first HF signal using the one or more second MF repeaters located in the enclosed space, and sending the second HF signal to a second HF radio. The method may include receiving the second HF signal using the second HF radio, producing audible voice using the voice information or data using the data information included in the second HF signal using the second HF radio.

Implementations of the method may include one, all, or some of the following:

Sending the MF signal may further include using a first omnidirectional antenna coupled with the MF repeater, and receiving the MF signal may further include using a second omnidirectional antenna coupled with the one or more second MF repeaters. The first and the second omnidirectional antennas may each include a wire loop and a single ferrite rod loop, where the single ferrite rod loop is oriented substantially parallel to a plane formed by the wire loop.

Each of sending the first HF signal and receiving the first HF signal may further include using a first HF omnidirectional antenna coupled with the first HF radio. The first HF omnidirectional antenna may include a first wire loop and a first single ferrite rod loop where the first single ferrite rod loop is oriented substantially parallel to a plane formed by the first wire loop. Each of sending the second HF signal and receiving the second HF signal may further include using a second HF omnidirectional antenna coupled with the second HF radio. The second HF omnidirectional antenna may include a second wire loop and a second single ferrite rod loop, where the second single ferrite rod loop is oriented substantially parallel to a plane formed by the second wire loop.

The method may further include sending the MF signal to at least one leaky feeder cable included within the enclosed space and receiving the MF signal from the at least one conductor using the one or more second MF repeaters included in the enclosed space.

Implementations of radio communication systems and HF-MF repeaters may utilize a method of using a virtual HF channel to enable radio communication in an enclosed space. The method may include sending a first HF signal on a first HF channel from a first HF radio, receiving the first HF signal with a first HF-MF repeater located in an enclosed space, and converting the first HF signal to a first MF signal using the first HF-MF repeater. The method may also include forming a virtual HF channel by sending into the enclosed space the first MF signal using a first MF antenna included in the first HF-MF repeater and receiving the first MF signal from the virtual HF channel in the enclosed space by using a second MF antenna included in a second HF-MF repeater. The method may further include converting the first MF signal to a second HF signal using the second HF-MF repeater and sending the second HF signal on a second channel to a second HF radio.

Implementations of a method of using a virtual HF channel to enable radio communication in an enclosed space may include one, all, or any of the following:

Forming a virtual HF channel by sending into the enclosed space the first MF signal may further include sending the first MF signal to a conductor using the first MF antenna and receiving the first MF signal from the virtual HF channel in the enclosed space may further include receiving the first MF signal from the conductor using the second MF antenna.

The first HF channel and the second HF channel may be the same HF frequency channel.

The MF antenna may be an omnidirectional antenna.

Implementations of radio communication systems and HF-MF repeaters may utilize implementations of a method of using an MF repeater network to transmit HF signals between a plurality of HF radios within an enclosed space. The method may include forming an MF network by providing two or more MF repeaters within an enclosed space. The two or more MF repeaters may be separated from each other within the enclosed space and in communication with each other through sending and receiving an MF signal with an MF antenna included in each of the two or more MF repeaters. The method may further include placing a plurality of HF radios distributed at locations within the enclosed space, the HF radios in direct connection with each other through the two or more MF repeaters of the MF network. Each of the plurality of HF radios may be in communication with one of the two or more MF repeaters and at least two of the plurality of HF radios may not be capable of communication between each other using HF signals.

Implementations of a method of using an MF repeater network to transmit HF signals between a plurality of HF radios within an enclosed space may utilize one, all, or some of the following:

The method may include forming the MF network by using a conductor to place at least two of the two or more MF repeaters in the MF network in communication with each other.

The MF antenna may be an omnidirectional antenna.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is a flowchart of an implementation of a method of communicating voice or data information in an enclosed space;

FIG. 2A is a block diagram of a first implementation of a radio communication system;

FIG. 2B is a block diagram of a second implementation of a radio communication system;

FIG. 2C is a block diagram of a third implementation of a radio communication system;

FIG. 3 is a block diagram of a fourth implementation of a radio communication system;

FIG. 4 is a front perspective view of an implementation of a radio frequency repeater;

FIG. 5A is a front perspective view of another implementation of a radio frequency repeater;

FIG. 5B is a side perspective view of the implementation of the radio frequency repeater illustrated in FIG. 5A;

FIG. 6 is a rear perspective view of an implementation of the radio frequency repeater like the one illustrated in FIG. 4 with the rear panel and side panels cut away;

FIG. 7 is a front view of another implementation of a radio frequency or HF-MF repeater;

FIG. 8 is a perspective view of another implementation of an HF-MF repeater.

FIG. 9 is a diagram of implementations of several HF-MF repeater units, a leaky feeder cable, a dedicated MF communication cable, and a plurality of HF radios illustrating various communication modes;

FIG. 10 is a flowchart of a method of using a virtual HF channel to enable radio communication in an enclosed space;

FIG. 11 is a flowchart of a method of using an MF repeater network to transmit HF signals between a plurality of HF radios within an enclosed space;

FIG. 12 is a perspective view of another an implementation of a radio frequency repeater;

FIG. 13 is a side view of the implementation of radio repeater.

### DESCRIPTION

This disclosure, its aspects and implementations, is not limited to the specific components or assembly procedures disclosed herein. Many additional components and assembly procedures known in the art consistent with the intended radio communication systems and enclosed space communications systems and/or assembly procedures for a radio communication system and/or enclosed space communication system will become apparent for use with particular implementations from this disclosure. Accordingly, for example, although particular implementations are disclosed, such implementations and implementing components may comprise any shape, size, style, type, model, version, measurement, concentration, material, quantity, and/or the like as is known in the art for such radio communication systems and enclosed space communication systems and implementing components, consistent with the intended operation.

Radio frequency communication in enclosed areas presents significant challenges. Enclosed areas may include many different use conditions, including, by non-limiting example, buildings, mine passageways and shafts, caves, man-made tunnels, subways, and any other structure or naturally occurring formation tending to inhibit transmission of radio waves. Because of the attenuating effect of solid materials on radio frequency electromagnetic radiation, higher frequency signals are often completely unable to pass through, thus terminating any potential communication between a radio unit inside an enclosed area and one outside. The degree of attenuation by the solid material, however, depends both upon the properties of the material and on the frequency of the radio radiation being used.

For high radio frequencies, such as those conventionally designated as high frequency (HF, 3-30 MHz), very high frequency (VHF, 30-300 MHz), or ultra-high frequency (UHF, 300-3000 MHz), the attenuation by solid materials such as rock is substantial. However, for radio frequencies in the medium frequency (MF, 300-3000 kHz or 0.3-3 MHz) or low frequency (LF, 30-300 kHz) ranges, substantial propagation of the radio waves has been observed, even through solid rock. In this document, the range of frequencies referred to by the abbreviation “HF” is used to refer to all frequencies greater than 3 MHz. The transmission of MF and LF signals is enhanced if metallic structures, such as ore deposits or conductors like wires, cables, rails, power cables, trolley lines, telephone lines, insulated wires, etc., lie along a propagation path. Such behavior is sometimes referred to as parasitic inductive coupling and can be used to link or enhance the link between two radio units. Because of this property of MF and LF signals, any powered or non-powered wire in the enclosed area can be used to propagate a signal.

In mining applications in particular, radio communication systems often involve the use of various HF radios (such as Kenwood® VHF or UHF radios) in combination with “leaky feeder” cable systems. A leaky feeder cable is designed to receive HF signals and transport them while allowing the signals to be rebroadcast along the cable's length. Many different conventional designs exist for leaky feeder cables, an example of which may be found in U.S. Pat. No. 5,465,395 to Bartram entitled “Communication via Leaky Cables,” issued Nov. 7, 1995, the disclosure of which is hereby incorporated herein by reference. When leaky feeder cable based communication systems are employed in mining operations, as long as an HF radio (either digital or analog) remains within range of a section of cable, it will remain connected to the system. The effective range of an HF radio in a mining tunnel depends both upon the distance from a leaky feeder cable section and whether the leaky feeder cable section is located around a bend in the tunnel or up a shaft. In an emergency situation, such as a cave in, since the leaky feeder cable is typically located along the top of a tunnel, the cable may be broken. When the leaky feeder cable is severed, HF signals may no longer be able to travel along the severed section of the leaky feeder cable, thus preventing all individuals using HF radios along the severed section from being able to communicate. Because the individuals along the severed section are most often those trapped, the immediate loss of communication adds to the critical nature of the emergency.

This document describes various systems, such as radio communication systems or enclosed space communication systems, along with various methods that are described primarily as utilizing MF radio frequency signals. However, the systems and methods disclosed in this document can also be implemented using LF or other additional frequency bands capable of penetrating through various enclosures. References in this document to HF radiation are equally applicable to VHF and UHF as well since, as was defined previously, the HF abbreviation is used to refer to all frequencies greater than 3 MHz.

The ability of MF signals to propagate through solid media can be utilized in systems employing radio frequency repeaters such as HF to MF (HF-MF) repeaters or MF repeaters as disclosed in this document. Some radio frequency repeaters may perform HF to MF conversions, while other radio frequency repeaters may only receive and transmit MF signals. In implementations performing HF to MF conversion, conventional HF radios are connected with the HF-MF repeaters and the HF signals generated by the HF radios (containing voice or data) are converted to corresponding MF signals and transmitted by the HF-MF repeaters through the boundaries of the enclosure. In particular implementations, various HF-MF repeaters may be connected through the MF signals to form an MF network allowing users of HF radios to communicate with other HF radio users out of ordinary HF signal range. Where the term HF-MF repeater is used in various places in this document, the term MF repeater is also equivalent. In implementations of systems utilizing HF-MF repeaters or radio frequency systems using only MF signals, various implementations of MF handheld radios may be utilized to transmit voice or data information.

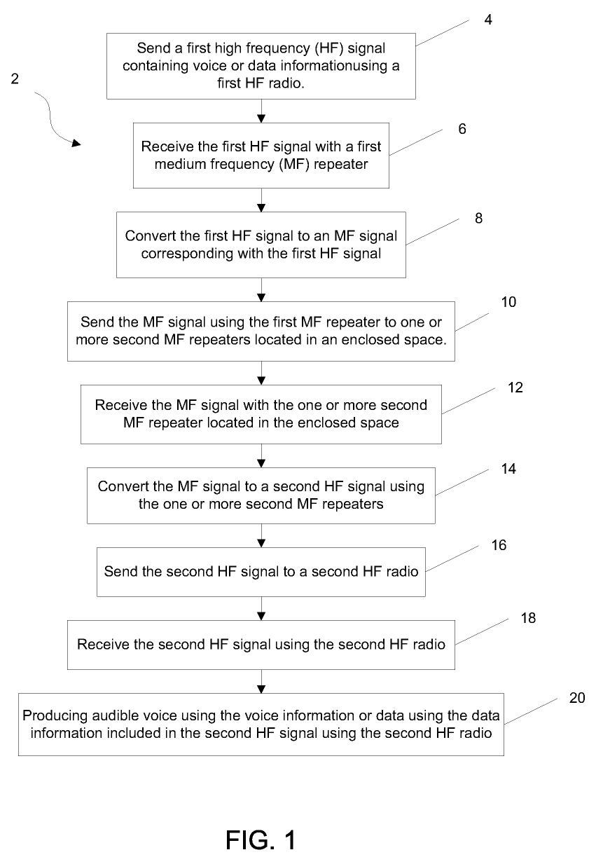

Referring to FIG. 1, an implementation of a method of communicating voice or data information in an enclosed space 2 is illustrated. As illustrated, the method 2 includes sending a first HF signal containing voice or data using a first HF radio (step 4), receiving the first HF signal with a first MF repeater (step 6), and converting the first HF signal to an MF signal corresponding with the first HF signal (step 8). The method 2 may also include sending the MF signal using the first MF repeater to one or more second MF repeaters located in an enclosed space (step 10), receiving the MF signal with the one or more second MF repeaters located in the enclosed space (step 12), and converting the MF signal to a second HF signal using the one or more second MF repeaters (step 14). The method 2 may include sending the second HF signal to a second HF radio (step 16), receiving the second HF signal using the second HF radio (step 18), and producing audible voice using voice information or data using data information included in the second HF signal using the second HF radio (step 20). As illustrated, the process of the method 2 involves taking the HF signal from an HF radio, converting it to an MF signal using an MF repeater, sending the MF signal to another MF repeater, and then reconverting it to an HF signal for reception by another HF radio. Any conductor (wire, leaky feeder cable, buried wire, etc.) located along the path of the MF signal between the MF repeaters may also be utilized in particular implementations during the sending and receiving steps of the method to carry the signal.

The process of sending and receiving HF and MF signals in implementations of the method 2 may involve communication on only one channel or a plurality of HF and/or MF channels. For example, the first HF signal and the second HF signal may ultimately be transmitted using the same HF channel. In other implementations, however, the HF channels may be different, or the signal may be broadcast in succession across a subset of, or all possible HF channels for frequency band segments. Transmission using a single HF channel may be utilized in conventional or in emergency operations, where a single channel is reserved for emergency use only. In other implementations, emergency procedures may require transmission across all channels in succession to alert everyone possible. In addition, the HF and/or MF signals may be transmitted by the MF repeaters and/or an MF network including two or more MF repeaters by means of broadcast, multicast, anycast, or unicast methods. Many potential channel configurations are possible when utilizing various implementations of the radio communication systems disclosed in this document.

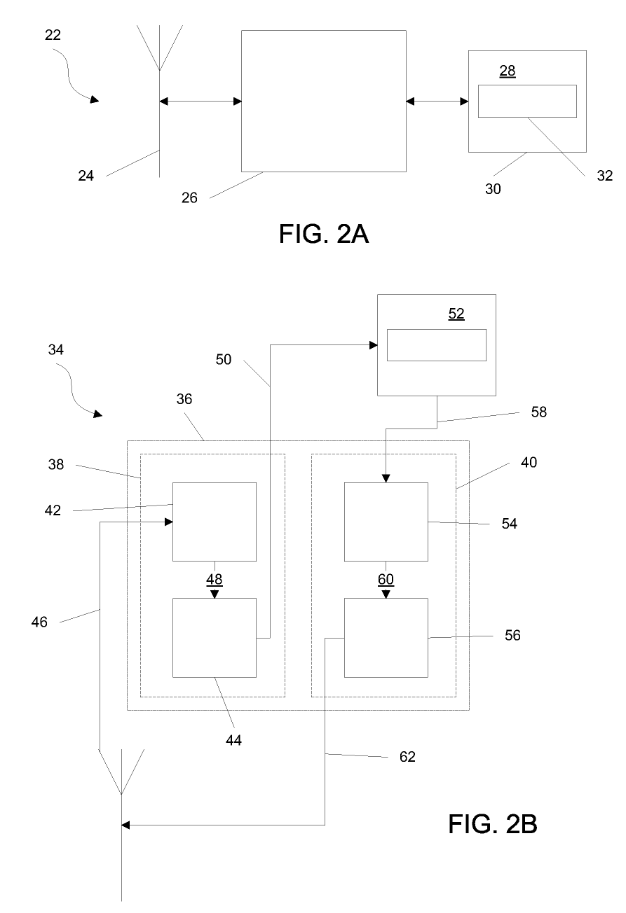

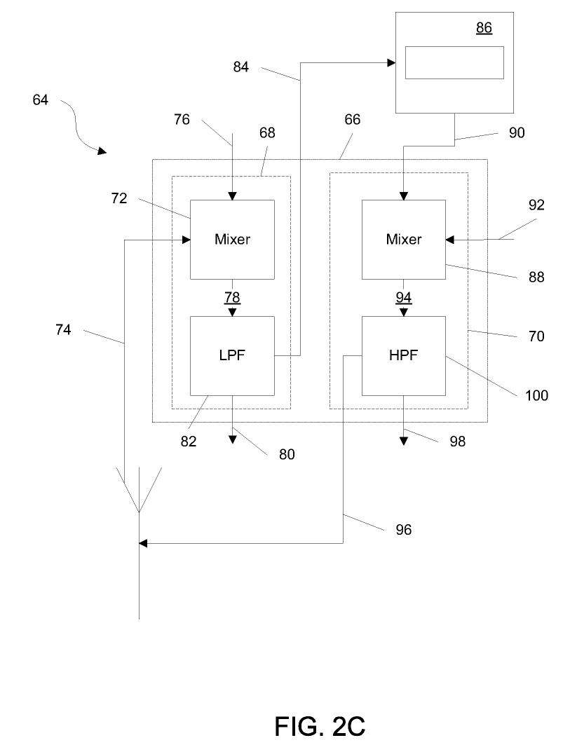

Referring to FIG. 2A, a first implementation of a radio communication system 22 is illustrated. As illustrated, the radio communication system 22 includes an HF antenna 24 coupled to an HF-MF analog converter module 26. The HF-MF analog converter module 26 is coupled in turn with an omnidirectional antenna 28 that includes a wire loop 30 and a single ferrite rod loop 32 located substantially parallel to a plane formed by the wire loop 30. As illustrated, the single ferrite rod loop 32 may be centered with respect to the wire loop 30. In other implementations, the single ferrite rod loop 32 may not be centered or even inside the wire loop 30 provided that it is still oriented substantially parallel to the plane formed by the wire loop 30. Relevant teachings regarding the structure, materials, and use of various implementations of omnidirectional antennas that may be employed in implementations of radio communication systems 22 may be found in U.S. patent application Ser. No. 11/970,142 to Pease entitled “Omnidirectional Antenna System,” filed Jan. 7, 2008, the disclosure of which is hereby incorporated herein by reference. In other implementations of radio communication repeaters (HF-MF or MF) discussed in this document, however, any other type of MF antenna could be utilized, whether omnidirectional or not such as, by non-limiting example, a single ferrite core antenna, a single wire loop, a double wire loop, a two crossed ferrite core antenna, or any other antenna structure.

The HF antenna 24 receives a first analog HF signal (such as one originating from an HF radio) and sends a second analog HF signal (such as one communicated by repeating using an MF signal from another HF-MF repeater). The HF-MF analog converter module 26 receives the first analog HF signal from the HF antenna and converts the first analog HF signal to a first analog MF signal. This conversion may be accomplished using any of a variety of analog signal conversion methods and systems in various implementations of HF-MF analog converter modules 26. The HF-MF analog converter module 16 also receives a second analog MF signal from the omnidirectional antenna 28 and converts the second analog MF signal to a second analog HF signal and sends the second analog HF signal to the HF antenna 24. The omnidirectional antenna 28 receives the first analog MF signal from the HF-MF analog converter module 26 and transmits the first analog MF signal into an enclosed space as well as receiving the second analog MF signal from the enclosed space and sending the second analog MF signal to the HF-MF analog converter module 26.

While many implementations of radio systems utilizing HF-MF analog converter modules 26 are possible, FIG. 2B illustrates a second implementation of a radio system utilizing an HF-MF analog converter module 34. As illustrated, the HF-MF analog converter module 36 of the radio system 34 includes an HF conversion side 38 and an MF conversion side 40. The HF conversion side 38 includes a first HF demodulator 42 coupled to a first MF modulator 44. The first HF demodulator 42 converts the first analog HF signal 46 to a first analog baseband signal 48. The first MF modulator 44 converts the first analog baseband signal 48 to the first analog MF signal 50, which is then routed to the omnidirectional antenna 52. Any other type of MF antenna disclosed in this document could also be utilized. The MF conversion side 40 includes a second MF demodulator 54 coupled with a second HF modulator 56. The second MF demodulator 54 converts the second analog MF signal 58 to a second analog baseband signal 60. The second HF modulator 56 converts the second analog baseband signal 60 to the second analog HF signal 62. Implementations of a radio system 34 may utilize any of a wide variety of conventional modulators and demodulators capable of converting either an HF or MF signal to a baseband signal or vice versa.

Referring to FIG. 2C, a second implementation of a radio system utilizing an HF-MF analog converter module 64 is illustrated. As illustrated, the HF-MF analog converter module 66 may include an HF conversion side 68 and an MF conversion side 70. The HF conversion side 68 includes a first radio frequency (RF) mixer 72 that multiplies the first analog HF signal 74 with a first analog pure wave signal 76 to produce an intermediate analog MF signal 78. The intermediate analog MF signal 78 includes a first analog MF signal 86 and a first analog sum frequency signal 80. A low pass filter 82 is coupled with the first RF mixer 72, receives the intermediate analog MF signal 78, and filters the first analog sum frequency signal 80 to produce the first analog MF signal 84, which is then sent to the omnidirectional antenna 86. Any other type of MF antenna could also be used in particular implementations. The MF conversion side 70 includes a second RF mixer 88 that multiplies the second analog MF signal 90 with a second analog pure wave signal 92 to produce an intermediate analog HF signal 94 including a second analog HF signal 96 and a second analog sum frequency signal 98. A high pass filter 100 is coupled with the second RF mixer 72, receives the intermediate analog HF signal 94, and filters the second analog sum frequency signal 98 to produce the second analog HF signal 96. While in FIG. 2C the first and second analog sum frequency signals 80, 98 are shown as exiting from the low pass filter 82 and high pass filter 100, respectively, in various implementations, the first and second analog sum frequency signals 80, 98 will be entirely canceled by the low pass filter 82 and the high pass filter 100 and thus no signal will be produced. Any of a wide variety of mixer types and low and high pass filter types may be used in particular implementations. In particular implementations, the first RF mixer 72 and second RF mixer 88 may be a single mixer configured to switch modes depending upon the frequency of the signal (HF/MF) being received.

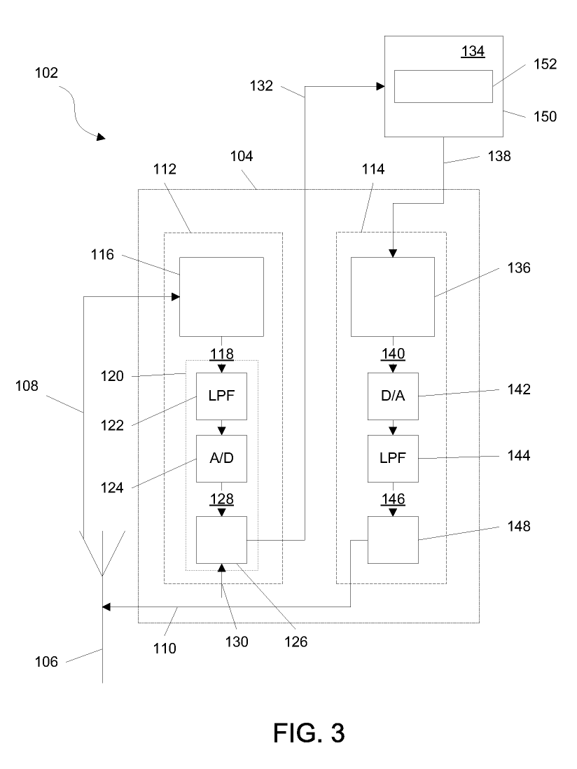

Referring to FIG. 3, an implementation of a radio system utilizing an HF-MF digital converter module 102 is illustrated. As illustrated, the radio system 102 includes an HF-MF digital converter module 104 coupled with an HF antenna 106 that receives a first analog HF signal 108 and a second analog HF signal 110. The HF-MF digital converter module 104 includes an HF conversion side 112 and an MF conversion side 114. The HF conversion side 112 includes an HF demodulator 116 that converts the first analog HF signal 108 to a first analog baseband signal 118. A digital modulator 120 is coupled with the HF demodulator 116 and includes a low pass filter 122, an analog-to-digital (A/D) converter 124, and a phase shift keyed (PSK) modulator 126. The low pass filter 122 and the A/D converter convert the first analog baseband signal 118 to a first digital baseband signal 128 and the PSK modulator 126 combines the first digital baseband signal 128 with an MF carrier signal 130 to produce a first digital MF signal 132. The first digital MF signal 132 then is sent to an omnidirectional antenna 134. Any other type of MF antenna disclosed in this document could also be utilized.

The MF conversion side 114 includes a PSK demodulator 136 that converts a second digital MF signal 138 from the omnidirectional antenna 134 to a second digital baseband signal 140. A digital-to-analog (D/A) converter 142 and a low pass filter 144 are coupled with the PSK demodulator 136 and converts the second digital baseband signal 140 to a second analog MF signal 146. An HF modulator 148 receives the second analog MF signal 146, converts the second analog MF signal 146 to the second analog HF signal 110, and sends the second analog HF signal 110 to the HF antenna 106. The omnidirectional antenna 134 includes a wire loop 150 and a single ferrite rod loop 152 oriented substantially parallel to a plane formed by the wire loop 150. The omnidirectional antenna 134 receives the first digital MF signal 132 from the HF-MF digital converter module 104 and transmits it into an enclosed space. The omnidirectional antenna 134 also receives the second digital MF signal 138 from the enclosed space and sends it to the HF-MF digital converter module 104.

While the use of a PSK demodulator 136 in the digital modulator 120 to generate the digital baseband signal 128 is illustrated in FIG. 3, any of a wide variety of digital modulation schemes or protocols including constant amplitude digital modulation may be utilized in particular implementations, including, by non-limiting example, frequency shift keying (FSK), binary phase shift keying (BPSK), Gaussian minimum shift keying (GMSK), quadrature amplitude modulation (QAM), or any other digital modulation technique. Also, while the use of HF analog signals has been illustrated in FIGS. 2A, 2B, 2C, and 3, digital HF signals and corresponding digital HF components utilizing any particular digital modulation technique could also be utilized. Also, any number of potential D/A and A/D converters, along with low pass filter implementations may be utilized. In addition, methods of speech modulation such as, by non-limiting example, advanced multiband excitation (AMBE), delta modulation, or any other method of speech modulation may be utilized. Also various methods of data transfer methods, including, by non-limiting example, ASCII, binary, file transfer protocol (FTP), transmission control protocol (TCP), or any other data transfer method or protocol, may be utilized to transfer data and/or aid in establishing connections between implementation of HF-MF repeaters or any other type of radio frequency repeater.

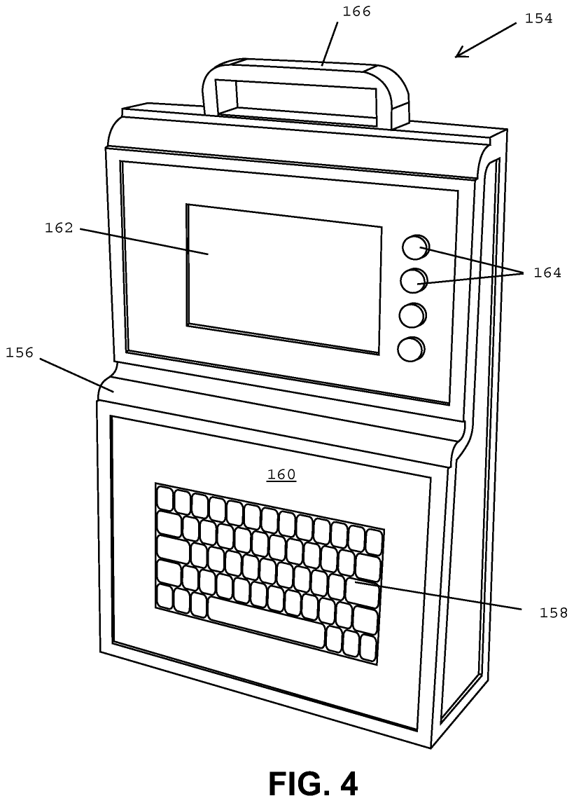

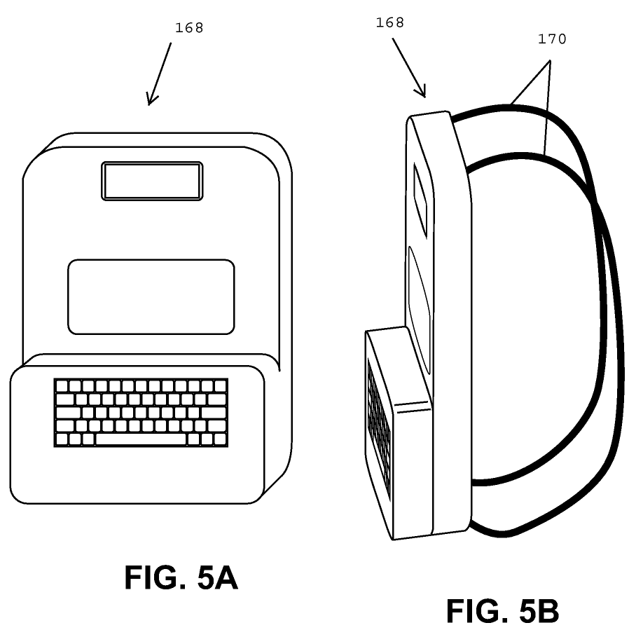

Implementations of radio systems may utilize various implementations of radio frequency repeaters, including HF-MF or MF repeaters. Referring to FIG. 4, an implementation of an HF-MF repeater 154 is illustrated. As illustrated, the HF-MF repeater 154 may include a housing 156 and a keyboard 158 capable of inputting various characters. In particular implementations, the keyboard 158 may be coupled in a surface 160 of the housing 156; in other implementations, the keyboard 158 may be coupled with the HF-MF repeater 154 through a wired or wireless connection. A display 162 may also be included to display one or more characters and may be any of a wide variety of display types, including, by non-limiting example, a light emitting diode (LED) display, a liquid crystal display (LCD), a cathode ray tube, or any other display system. Implementations of HF-MF repeaters 154 having keyboards 158 and displays 162 may be capable of sending pictures, text, and other data as well as audio. A plurality of input/output buttons or input/output ports 164 may be included to allow for operation of various features of the display 162 or to permit any of a wide variety of input/output devices to be coupled with the HF-MF repeater 154. Some of these input/output devices may include, by non-limiting example, a handheld microphone/speaker, a flash drive, a light, a speaker, a computer, or any other electronic device. A handle 166 for carrying of the HF-MF repeater 154 may also be included.

Referring to FIGS. 5A and 5B, another implementation of an HF-MF repeater 168 is illustrated. As illustrated, the HF-MF repeater 168 has a different overall shape and lacks a handle projecting from the housing, however, the HF-MF repeater 168 includes shoulder straps 170 that allow a user to carry the unit on his or her back. Other implementations of HF-MF repeaters may include the capability to be carried via handle and shoulder straps, as well as capabilities for permanent or semi-permanent mounting to floors, walls, or ceilings of enclosures such as mine tunnels.

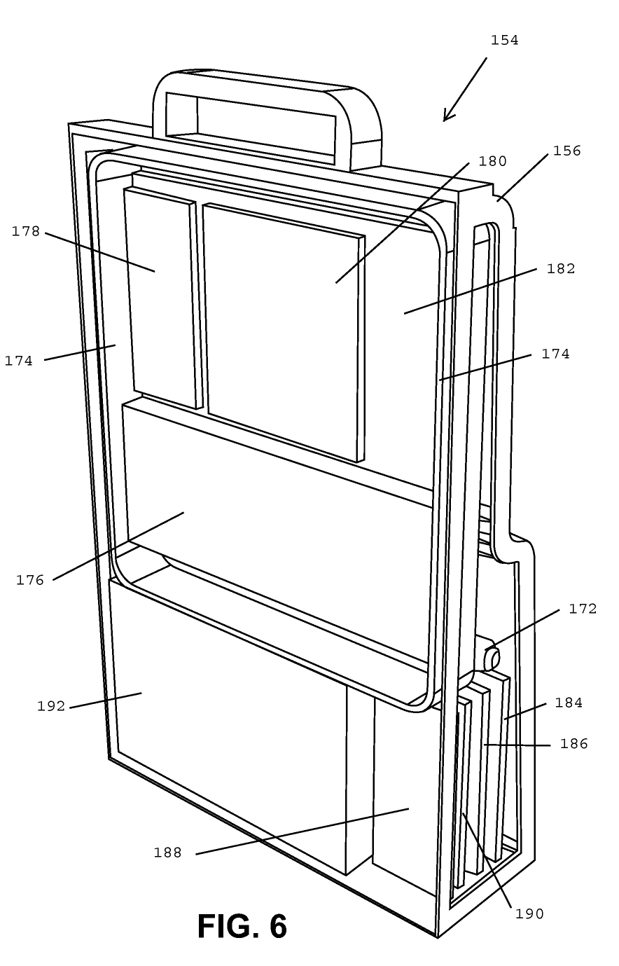

Referring to FIG. 6, a rear perspective view of the implementation of the HF-MF repeater 154 illustrated in FIG. 4 is illustrated with rear and side portions of the housing 156 removed. As illustrated, the HF-MF repeater 154 includes an HF antenna 172 and an omnidirectional antenna including a wire loop 174 with a single ferrite rod loop 176. As illustrated, the single ferrite rod loop 176 is oriented substantially parallel to a plane formed by the wire loop and is not centered with respect to the wire loop 174. In other particular implementations of omnidirectional antennas, the single ferrite rod loop 176 may be located outside the wire loop 174 provided that it remains oriented substantially parallel to the plane formed by the wire loop 174. In other particular implementations, the HF-MF repeater 154 may include any of the previously discussed MF antenna types and may not be omnidirectional.

As illustrated, an antenna matching network board 178, frequency translating board 180, and radio board 182 may all be included. In particular implementations of HF-MF repeaters 154, one or more of these three boards may not be included or the functionality of one or more of these three boards may be incorporated into one or more boards or into another portion of the HF-MF repeaters. In various implementations, only a frequency translating circuit may be included that may include the functionality of the antenna matching network board 178, the frequency translating board 180 and/or the radio board 182. The frequency translating circuit may be included in one or more circuit boards. An MF transceiver 184 and HF transceiver 186 may also be included and the combination of the antenna matching network board 178, frequency translating board 180, radio board 182, MF transceiver 184, and HF transceiver 186 may perform a majority of the HF to MF frequency reception, conversion, and tuning required for the HF-MF repeater 154 to operate. In other particular implementation, additional boards and/or devices may be included to perform any of the HF to MF frequency reception, conversion, and tuning functions. Implementations may also include boards that combine the functionality of the MF transceiver 184 and/or the HF transceiver 186 with the frequency translating circuit in one or more boards. A digital input/output (I/O) control board 188 may also be included to allow some or all of the other boards and devices in the HF-MF repeater 154 to interface with each other. The digital I/O control board 188 may also communicate with the display 162 and keyboard 158. A battery charging circuit 190 and battery 192 may also be included and may be incorporated within the housing 156 of the HF-MF repeater 154. In other implementations, the battery 192 and battery charging circuit 190 may be external to the housing 156 or not included, as in radio frequency repeater units, like HF-MF repeater and MF repeater units that rely wholly on an external power source.

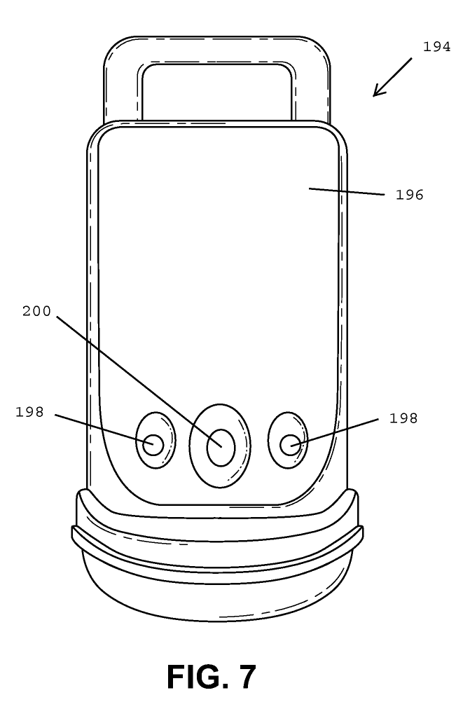

Referring to FIG. 7, another implementation of a radio frequency repeater 194 is illustrated. As illustrated, the radio frequency repeater 194 may include a ruggedized housing or enclosure 196. The enclosure 196 may be made of any of wide variety of rugged materials, such as, by non-limiting example, polycarbonates, metals, Kevlar®, Lexan®, composites, or any other durable material. The enclosure 196 may also be explosion proof (XP) and may be designed to comply with various military and governmental safety standards, such as U.S. MIL-STD 810 and other regulations promulgated by the U.S. Mine Safety and Health Administration (MSHA). Various indicator lights 198 and one or more I/O ports 200 and a power switch may also be included as part of the radio frequency repeater 194. In particular implementations of radio frequency repeaters, speaker/microphone units may also be coupled with the radio frequency repeaters through the one or more I/O ports 200 or may be permanently connected with the radio frequency repeaters. The use of ruggedized enclosures may allow the radio frequency repeater 194 to be carried by its handle 202 throughout a mine or other enclosed space without being damaged by bumping into obstacles, falls, or being set down on rough and rocky surfaces. The radio frequency repeater 194 illustrated in FIG. 7 may operate using either digital or analog radio components. In particular implementations, the handle 202 may be located on the longer dimension of the radio frequency repeater 194.

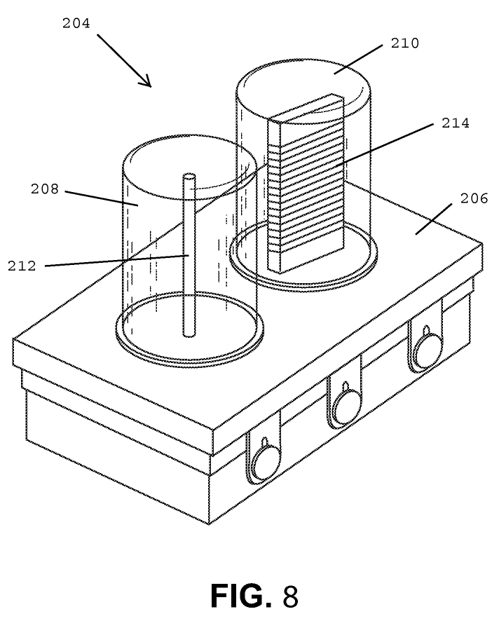

Referring to FIG. 8, another implementation of an radio frequency repeater 204 is illustrated. As illustrated, the radio frequency repeater 204 implementation has a housing 206 which may be made of any of a wide variety of materials, and a first dome 208 and a second dome 210 that extend from the housing 206. Within the first dome 208 may be an HF antenna 212, and within the second dome 210 may be a MF antenna 214. The MF antenna 214 may be any of the omnidirectional or non-omnidirectional types discussed in this document. In the implementation illustrated in FIG. 8, the antenna is a single ferrite loop antenna including a wire loop wrapped around a single ferrite rod. The orientation of windings of the wire loop can be wound in any orientation or combination. The extending of the HF antenna 212 and the omnidirectional antenna 214 into the first dome 208 and second dome 210, respectively, may allow the radio frequency repeater 204 to operate without undue interference if the housing 206 is constructed of a metal or other rugged material. The first dome 208 and second dome 210 may be constructed of a wide variety of the previously mentioned rugged non-metallic materials such as Lexan® to permit transmission of the HF and MF signals through them. In the implementation of the radio frequency repeater 204 illustrated in FIG. 8, the housing 206 is constructed of an aluminum material and may be explosion proof (XP). Implementations of radio frequency repeaters 204 may be used primarily with analog radios, although digital radio components could also be used in particular implementations.

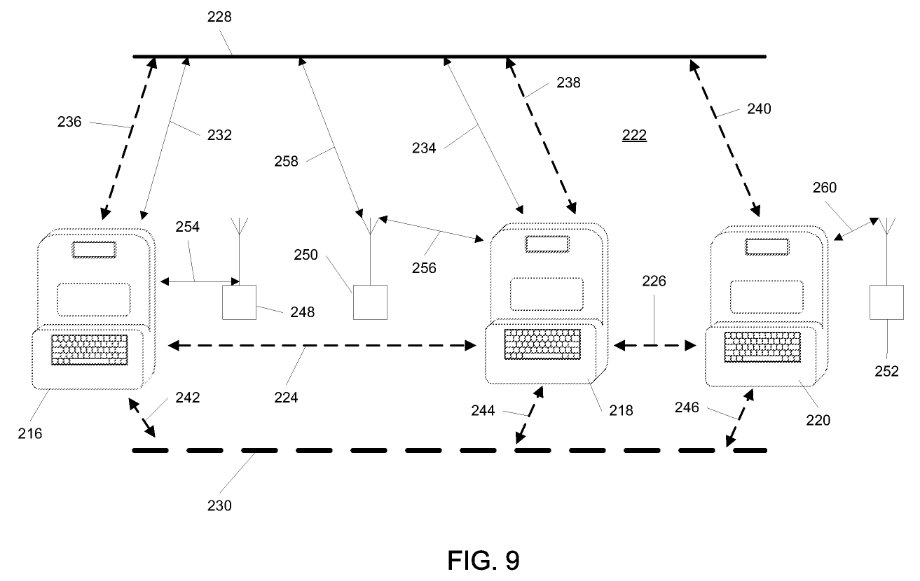

Implementations of radio frequency repeaters 154, 168, 194, and 204 may be utilized in combination with implementations of HF radios in a wide variety of ways. Referring to FIG. 9, a diagram of various radio frequency repeaters 216, 218, and 220 (here HF-MF repeaters or MF repeaters) are shown in an enclosed space 222. In the diagram in FIG. 9, dashed lines indicate MF signals and solid lines indicate HF signals. The HF-MF repeaters 216, 218, and 220 can be directly connected via the direct MF signals 224 and 226. In particular implementations of radio frequency repeaters, if the HF-MF repeaters 216, 218, and 220 utilize analog radio components, any two of the repeaters may be capable of direct connection, but not all three simultaneously. For example, if the direct MF signal 226 was sent from HF-MF repeater 220 to HF-MF repeater 218, HF-MF repeater 218 could not then forward that MF signal to HF-MF repeater 216. In other words, implementations of radio frequency repeaters utilizing analog radio components may not be able to “hop” MF signals from repeater to repeater. According, any MF networks formed using direct repeater to repeater MF connections may be no larger than two repeaters in size.

However, in implementations of radio frequency repeaters utilizing digital radio components, the various radio frequency repeaters may be able to hop MF signals from repeater to repeater. In addition, the various radio frequency repeaters may be able to maintain direct MF signal connections with more than one repeater at a time and form a “mesh” MF network capable of distributing MF signals along the multiple pathways created by the multiple connections. In such MF networks, any of the previously discussed signal transmission techniques can be used to route MF signals (broadcast, anycast, etc).

As illustrated, the HF-MF repeaters 216, 218, and 220 may connect to each other through more than just the direct MF signals 224 and 226 by using a leaky feeder cable 228 and/or a conductor 230, which may be any powered or non-powered wire or piece of metal in the enclosed area. When making connections using the leaky feeder cable 228 and/or the conductor 230, the leaky feeder cable 228 or the conductor 230 may be considered a part of the MF network because each is serving as a signal relay to enable one or more HF-MF repeaters to communicate with each other. As illustrated, HF-MF repeaters 216 and 218 may communicate using the leaky feeder cable 228 using either HF signals 232, 234 or the MF signals 236, 238. Because the leaky feeder cable 228 can relay both HF signals and MF signals, either form of signal can be used to connect the HF-MF repeaters with each other. While connection through HF signals may be possible, particular implementations of HF-MF repeaters may be programmed to connect only through MF signals, as is illustrated by MF signal 240 and HF-MF repeater 220. Also, where leaky feeder cables 228 are not present, if a conductor 230 is present in the mine, the HF-MF repeaters may communicate with each other and form an MF network using MF signals 242, 244, and 246. In particular implementations of HF-MF repeaters, connections between the HF-MF repeaters may be effected by using both HF and MF signals and the leaky feeder cable 228 and MF signals through the dedicated MF communication cable.

A plurality of HF radios 248, 250, and 252 may be distributed throughout the enclosed space 222 and may communicate with each other and with the HF-MF repeaters 216, 218, and 220 in various configurations. For example, HF radio 248, not in direct connection with HF radio 250 through an HF signal, may be placed in communication by connecting with HF-MF repeater 216 through HF signal 254 and then by using MF signal 236, the leaky feeder cable 228, MF signal 238, and HF signal 256 to complete the connection. Alternatively, the HF-MF repeaters 218 and 218 may be operated as HF only signal repeaters and use HF signals 254 and 232, the leaky feeder cable 228, and HF signals 234 and 256 to make the connection. Because the HF radios are capable of communicating directly through the leaky feeder cable 228, HF radio 250 may also communicate with HF radio 248 by using HF signal 258, the leaky feeder cable 228 and HF signals 232 and 254. While the leaky feeder cable 228 has been used in these illustrations to aid in connecting the two HF radios together, MF signal 224 or MF signals 242 and 224 in combination with the conductor 230 could also be used to make the connections.

When MF signals are used to connect two HF radios together, such as is illustrated when HF radio 252 is connected with HF radio 250 through HF signal 260, MF signals 240 and 238 and HF signal 256, a virtual HF channel can be created using the HF-MF converters 218, 220. Because HF radios can receive HF signals on various channels, one HF radio 250 may be set to receive HF signals on a different channel than an HF radio 252 located in a different part of the enclosed space 222. However, if those same two HF radios 250, 252 were connected via different HF channels to two different HF-MF repeaters 218, 220, they would still be in communication via the MF signals 238, 240 despite using different HF channels. Accordingly, the MF signals 239, 240 and the HF-MF repeaters 218, 220 may form a virtual HF channel, allowing different HF radios on different HF channels connected to different MF repeaters to stay in communication with each other. In other arrangements, all of the HF radios may be connected to the same HF channel, but may be completely out of HF signal range from each other as is illustrated by HF radios 252 and 250. When connected through HF-MF repeaters 220, 218 and MF signals 240, 238, a virtual HF channel may be formed to still allow the HF radios 252 and 250 to remain in communication with each other on the same HF channel.

As illustrated in FIG. 9, the HF-MF repeaters 216, 218, and 220 may also form an MF network that allows the plurality of HF radios 248, 250, and 252 to connect with each other even if at least two of the HF radios are not in direct connection. Also, when the HF-MF repeaters 216, 218, and 220 are connected as a mesh MF network, signals from the HF radios 248, 250, and 252 can be routed in any particular order. For example, HF radio 248 may be connected with HF radio 250 by HF signal 254, MF signal 242, the conductor 230, MF signal 246, MF signal 226, and HF signal 256. Any of a wide variety of other signal routing possibilities could be used. When an MF network or mesh MF network is formed, connection redundancy for each HF radio in the network may be enhanced because if a particular HF-MF repeater fails or is destroyed in an accident, MF signals can still be rerouted using other already connected and available repeaters. Also, implementations of radios transmitting and receiving only MF signals may be utilized in conjunction with the HF-MF repeaters 216, 218, 220 and may be handheld or fixed position radios.

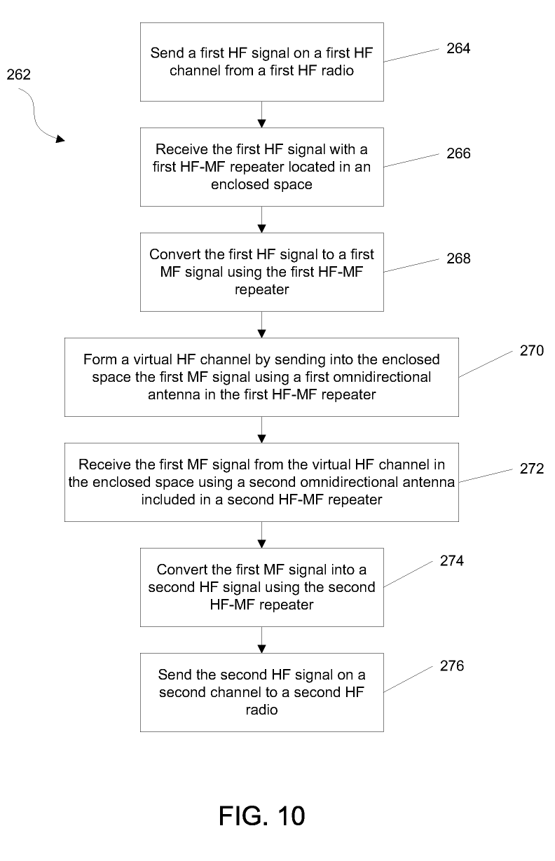

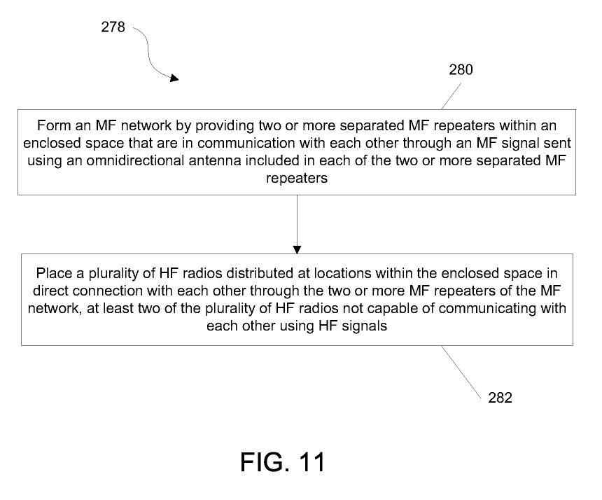

FIG. 10 illustrates an implementation of a method of using a virtual HF channel to enable radio communication in an enclosed space 262. As illustrated, the method 262 includes sending a first HF signal on a first HF channel from a first HF radio (step 264), receiving the first HF signal with a first HF-MF repeater located in an enclosed space (step 266), and converting the first HF signal to a first MF signal using the first HF-MF repeater (step 268). The method 262 also includes forming a virtual HF channel by sending into the enclosed space the first MF signal using a first omnidirectional antenna in the first HF-MF repeater (step 270) and receiving the first MF signal from the virtual HF channel in the enclosed space using a second omnidirectional antenna included in a second HF-MF repeater (step 272). The method 262 includes converting the first MF signal into a second HF signal using the second HF-MF repeater and sending the second HF signal on a second channel to a second HF radio (step 276). In implementations of the method 262, the first HF channel actually being used by the first HF radio may be the same channel (same frequency channel or frequency band segment) as the second HF channel being utilized by the second HF radio. In other implementations, the first HF channel and second HF channel may be different channels occupying separate segments of the frequency band. In particular implementations of the method 262, any conductor may be utilized to form the virtual HF channel. Also, any combination of radio frequency repeaters disclosed in this document may be utilized in implementations of the method.

Referring to FIG. 1, an implementation of a method of using an MF repeater network to transmit HF signals between a plurality of HF radios within an enclosed space 278 is illustrated. As illustrated, the method 278 includes forming an MF network by providing two or more separate radio frequency repeaters, which may be HF-MF repeaters or MF repeaters, within an enclosed space that are in communication with each other through an MF signal sent using an omnidirectional antenna included in each of the two or more separate MF repeaters (step 280). The method 278 also includes placing a plurality of HF radios distributed at locations within the enclosed space in direct connection with each other through the two or more MF repeaters of the MF network where at least two of the plurality of HF radios are not capable of communicating with each other using HF signals. In particular implementations, a conductor may be incorporated into the MF network to place at least two of the two or more MF repeaters in the MF network in communication with each other.

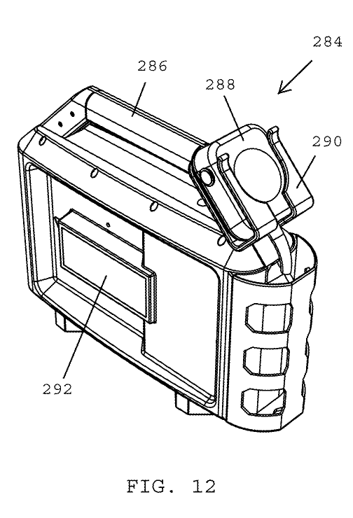

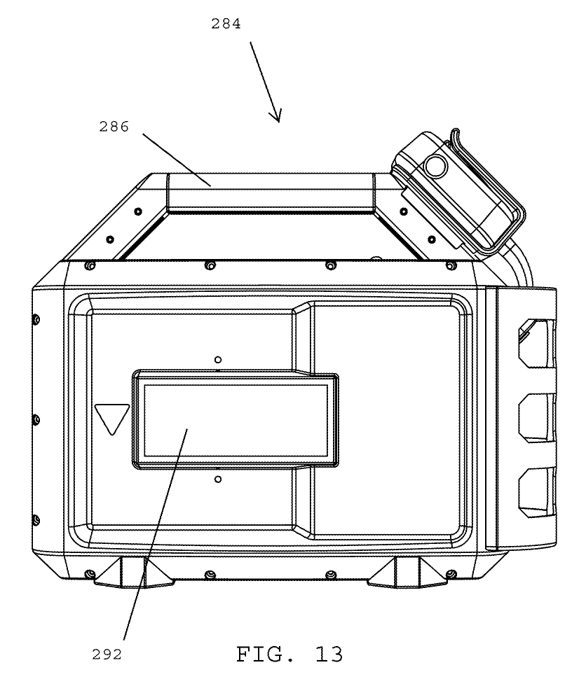

Referring to FIG. 12, another implementation of a radio frequency repeater 284, which may be any HF-MF or MF repeater, is illustrated. As illustrated, the radio frequency repeater 284 may include a handle 286 along a long dimension of the radio frequency repeater 284 and a retractable speaker/microphone unit 288 coupled with a holder 290. In particular implementations, a display 292 may be included in a side of the radio frequency repeater 284. Displays 292 may be included particularly in implementations of radio frequency repeaters 284 that utilize digital radio components. Various system components (keyboards, buttons, selectors, and the like) may also be included to allow for the sending and receiving of character-based messages. FIG. 13 is a side view of the implementation of a radio frequency repeater 284 illustrated in FIG. 12 further showing the handle 286 and display 292.

In places where the description above refers to particular implementations of radio communication systems, enclosed space communication systems, and various related methods, it should be readily apparent that a number of modifications may be made without departing from the spirit thereof and that these implementations may be applied to other radio communication systems, enclosed space communication systems, and various related methods.

1. A method of communicating voice or data information in an enclosed space, the method comprising:
sending a first high frequency (HF) signal using a first HF radio, the first HF signal comprising voice information or data information received by the first HF radio;
receiving the first HF signal with a first medium frequency (MF) repeater;
converting the first HF signal to an MF signal corresponding with the first HF signal using the first MF repeater;
sending the MF signal using the first MF repeater to one or more second MF repeaters located in an enclosed space;
receiving the MF signal with the one or more second MF repeaters located in the enclosed space;
converting the MF signal to a second HF signal corresponding with the first HF signal using the one or more second MF repeaters located in the enclosed space;
sending the second HF signal to a second HF radio;
receiving the second HF signal using the second HF radio; and
producing audible voice using the voice information or data using the data information included in the second HF signal using the second HF radio.

2. The method of claim 1, wherein sending the MF signal further comprises using a first omnidirectional antenna coupled with the MF repeater, and wherein receiving the MF signal further comprises using a second omnidirectional antenna coupled with the one or more second MF repeaters, and wherein the first and the second omnidirectional antennas each comprise a wire loop and a single ferrite rod loop, wherein the single ferrite rod loop is oriented substantially parallel to a plane formed by the wire loop.

3. The method of claim 2, wherein each of sending the first HF signal and receiving the first HF signal further comprise using a first HF omnidirectional antenna coupled with the first HF radio, the first HF omnidirectional antenna comprising a first wire loop and a first single ferrite rod loop, wherein the first single ferrite rod loop is oriented substantially parallel to a plane formed by the first wire loop, and wherein each of sending the second HF signal and receiving the second HF signal further comprise using a second HF omnidirectional antenna coupled with the second HF radio, the second HF omnidirectional antenna comprising a second wire loop and a second single ferrite rod loop, wherein the second single ferrite rod loop is oriented substantially parallel to a plane formed by the second wire loop.

4. The method of claim 3, further comprising sending the MF signal to at least conductor included within the enclosed space and receiving the MF signal from the at least one conductor using the one or more second MF repeaters included in the enclosed space.

5. A system for communicating voice or data information in an enclosed space, the system comprising:
an HF antenna, the HF antenna configured to receive a first analog HF signal and to send a second analog HF signal;
an HF-MF analog converter module coupled with the HF antenna and configured to:
receive the first analog HF signal from the HF antenna and convert the first analog HF signal to a first analog MF signal;
receive a second analog MF signal, convert the second analog MF signal to a second analog HF signal, and send the second analog HF signal to the HF antenna; and
an omnidirectional antenna coupled with the HF-MF analog converter module and comprising a wire loop and a single ferrite rod loop, wherein the single ferrite rod loop is oriented substantially parallel to a plane formed by the wire loop;
wherein the omnidirectional antenna is configured to:
receive the first analog MF signal from the HF-MF analog converter module and transmit the first analog MF signal into an enclosed space; and
receive the second analog MF signal from the enclosed space and send the second analog MF signal to the HF-MF analog converter module.

6. The system of claim 5, wherein the HF-MF analog converter module comprises:
an HF conversion side comprising a first HF demodulator coupled with a first MF modulator, the first HF demodulator configured to convert the first analog HF signal to a first analog baseband signal and the first MF modulator configured to convert the first analog baseband signal to the first analog MF signal; and
an MF conversion side comprising a second MF demodulator coupled with a second HF modulator, the second MF demodulator configured to convert the second analog MF signal to a second analog baseband signal and the second HF modulator configured to convert the second analog baseband signal to the second analog HF signal.

7. The system of claim 5, wherein the HF-MF analog converter module comprises:
an HF conversion side comprising:
a first radio frequency (RF) mixer configured to multiply the first analog HF signal with a first analog pure wave signal to produce an intermediate analog MF signal comprising the first analog MF signal and a first analog sum frequency signal; and
a low pass filter coupled with the first RF mixer and configured to receive the intermediate analog MF signal and filter the first analog sum frequency signal to produce the first analog MF signal; and
an MF conversion side comprising:
a second RF mixer configured to multiply the second analog MF signal with a second analog pure wave signal to produce an intermediate analog HF signal comprising the second analog HF signal and a second analog sum frequency signal; and
a high pass filter coupled with the second RF mixer and configured to receive the intermediate analog HF signal and filter the second analog sum frequency signal to produce the second analog HF signal.

8. The system of claim 5, wherein the MF antenna is further configured to transmit the first analog MF signal to a conductor included in the enclosed space and to receive the second analog MF signal from the conductor.

9. A system for communicating voice or data information in an enclosed space, the system comprising:
an HF antenna, the HF antenna configured to receive a first analog HF signal and to send a second analog HF signal;
an HF-MF digital converter module coupled with the HF antenna and comprising:
an HF conversion side comprising:
an HF demodulator configured to convert the first analog HF signal to a first analog baseband signal; and
a digital modulator coupled with the HF demodulator, the digital modulator comprising a low pass filter, an analog-to-digital (A/D) converter, and a constant amplitude digital modulator, the low pass filter and A/D converter configured to convert the first analog baseband signal to a first digital baseband signal and the constant amplitude digital modulator configured to combine the first digital baseband signal with an MF carrier signal to produce a first digital MF signal;
an MF conversion side comprising:
a constant amplitude digital demodulator configured to convert a second digital MF signal to a second digital baseband signal;
a digital-to-analog (D/A) converter and low pass filter configured to convert the second digital baseband signal to a second analog MF signal; and
an HF modulator configured to convert the second analog MF signal to a second analog HF signal; and
an MF antenna coupled with the HF-MF digital converter module wherein the MF antenna is configured to:
receive the first digital MF signal from the HF-MF digital converter module and transmit the first digital MF signal into an enclosed space; and
receive the second digital MF signal from the enclosed space and send the second digital MF signal to the HF-MF digital converter module.

10. The system of claim 9, wherein the MF antenna is an omnidirectional antenna coupled with the HF-MF digital converter module and comprising a wire loop and a single ferrite rod loop, wherein the single ferrite rod loop is oriented substantially parallel to a plane formed by the wire loop.

11. The system of claim 9, wherein the MF antenna is further configured to transmit the first digital MF signal to a conductor included in the enclosed space and to receive the second digital MF signal from the conductor.

12. An HF-MF repeater comprising:
an HF antenna coupled with the HF-MF repeater, the HF antenna configured to receive a first HF signal and to send a second HF signal to one or more HF radios;
an MF antenna coupled with the HF-MF repeater, the MF antenna configured to receive a second MF signal and to send a first MF signal to one or more MF repeaters;
a frequency translating circuit coupled with the MF antenna and with the HF antenna;
an MF transceiver coupled with the MF antenna; and
an HF transceiver coupled with the HF antenna.

13. The repeater of claim 12, wherein the first MF signal is a first digital MF signal, the second MF signal is a second digital MF signal, the radio board is a digital radio board, and the MF transceiver is a digital MF transceiver.

14. The repeater of claim 12, wherein the first MF signal is a first analog MF signal, the second MF signal is a second analog MF signal, the radio board is an analog radio board, and the MF transceiver is an analog MF transceiver.

15. The repeater of claim 12, wherein the MF antenna is further configured to send the first MF signal to or to receive the second MF signal from a conductor.

16. The repeater of claim 12, wherein the HF transceiver is configured to send two or more HF signals to a plurality of HF radios and may be configured to receive two or more HF signals from a plurality of HF radios.

17. The repeater of claim 12, further comprising a housing, and wherein the HF antenna and the MF antenna extend from the housing.

18. The repeater of claim 12, further comprising a keyboard configured to input one or more characters and a display configured to show one or more characters, the keyboard and the display coupled with the HF-MF repeater and coupled with a digital input/output (I/O) control board.

19. The repeater of claim 12, further comprising a housing and comprising one or more I/O ports in a surface of the housing.

20. The repeater of claim 12, wherein the MF antenna is an omnidirectional antenna coupled with the HF-MF repeater and comprising a wire loop and a single ferrite rod loop, wherein the single ferrite rod loop is oriented substantially parallel to a plane formed by the wire loop.

21. The repeater of claim 12, further comprising a battery charging circuit coupled with a battery coupled with the HF-MF repeater.

22. The repeater of claim 12, wherein the frequency translating circuit further comprises an antenna matching circuit and a radio circuit.

23. The repeater of claim 22, wherein the frequency translating circuit, the antenna matching circuit, and the radio circuit are comprised in one or more boards.

24. A method of using a virtual HF channel to enable radio communication in an enclosed space, the method comprising:
sending a first HF signal on a first HF channel from a first HF radio;
receiving the first HF signal with a first HF-MF repeater located in an enclosed space;
converting the first HF signal to a first MF signal using the first HF-MF repeater;
forming a virtual HF channel by sending into the enclosed space the first MF signal using a first MF antenna included in the first HF-MF repeater;
receiving the first MF signal from the virtual HF channel in the enclosed space by using a second MF antenna included in a second HF-MF repeater;
converting the first MF signal to a second HF signal using the second HF-MF repeater; and
sending the second HF signal on a second channel to a second HF radio.

25. The method of claim 24, wherein forming a virtual HF channel by sending into the enclosed space the first MF signal further comprises sending the first MF signal to a conductor using the first MF antenna and receiving the first MF signal from the virtual HF channel in the enclosed space further comprises receiving the first MF signal from the conductor using the second MF antenna.

26. The method of claim 24, wherein the first HF channel and the second HF channel are the same HF frequency channel.

27. The method of claim 24, wherein the MF antenna is an omnidirectional antenna.

28. A method of using an MF repeater network to transmit HF signals between a plurality of HF radios within an enclosed space, the method comprising:
forming an MF network by providing two or more MF repeaters within an enclosed space, the two or more MF repeaters separated from each other within the enclosed space and in communication with each other through sending and receiving an MF signal with an MF antenna included in each of the two or more MF repeaters;
placing a plurality of HF radios distributed at locations within the enclosed space, the HF radios in direct connection with each other through the two or more MF repeaters of the MF network, each of the plurality of HF radios in communication with one of the two or more MF repeaters and at least two of the plurality of HF radios not capable of communication between each other using HF signals.

29. The method of claim 28, further comprising forming the MF network by using a conductor to place at least two of the two or more MF repeaters in the MF network in communication with each other.

30. The method of claim 28, wherein the MF antenna is an omnidirectional antenna.
